(19) United States
(12) Patent Application Publication
(10) Pub. No.: US 2006/0102680 A1
(43) Pub. Date: May 18, 2006

(54) Easy lift rack

(76) Inventor: Marc Joseph Stannard, Essex Jct, VT (US)

Correspondence Address: MARC STANNARD, 5 WARNER AVE, ESSEX JCT, VT, 05452, US

(21) Appl. No.: 10/988,383

(22) Filed: Nov. 12, 2004

(51) Int. Cl. B60R 9/00

(52) U.S. Cl. 224/924; 224/321

(57) ABSTRACT

Every rack on the market today has one drawback. You have to open your vehicle door, step half way into your vehicle or step on your tire, then with one hand lift your bike to the roof rack while holding onto the vehicle with the other hand, all while keeping your balance and not dropping yourself, the bike, or both. The “easy lift rack” eliminates these problems altogether. By squeezing the lever, unlock the fork mounted or wheel mounted tray (whichever you may have). Then allow the device to work for you. (It works with all trays.) The “easy lift rack” works by having two hinges and an internal spring that move at the same time to lower the bike to you. The device functions similar to the way a crane would lower its load minus the cables. When you are through riding your bike, simply life your bike onto the bike rack (less than half the distance as conventional methods would have you do) lock it down, and with the help of the internal spring and a little effort, your bike will be lifted to the locked position on top of your vehicle. Then, drive away.

### SUMMARY OF INVENTION

This device works with any bike tray and rack system, and is capable of conforming to the user's needs. It comes to the user instead of having the user stand on a tire or the inside of the vehicle to mount a bike. This device is mainly for SUVs or trucks with cabs, but can be used for cars, as well.

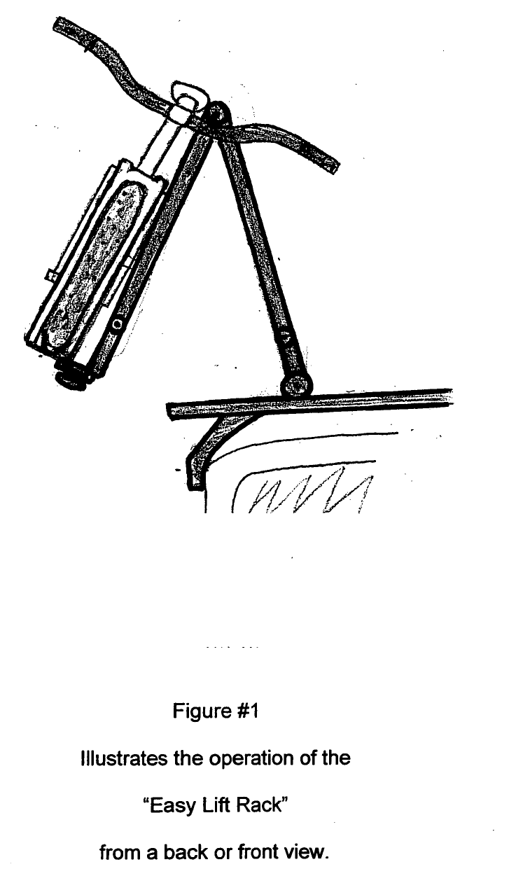

FIG. 1 illustrates the operation from a back or front view.

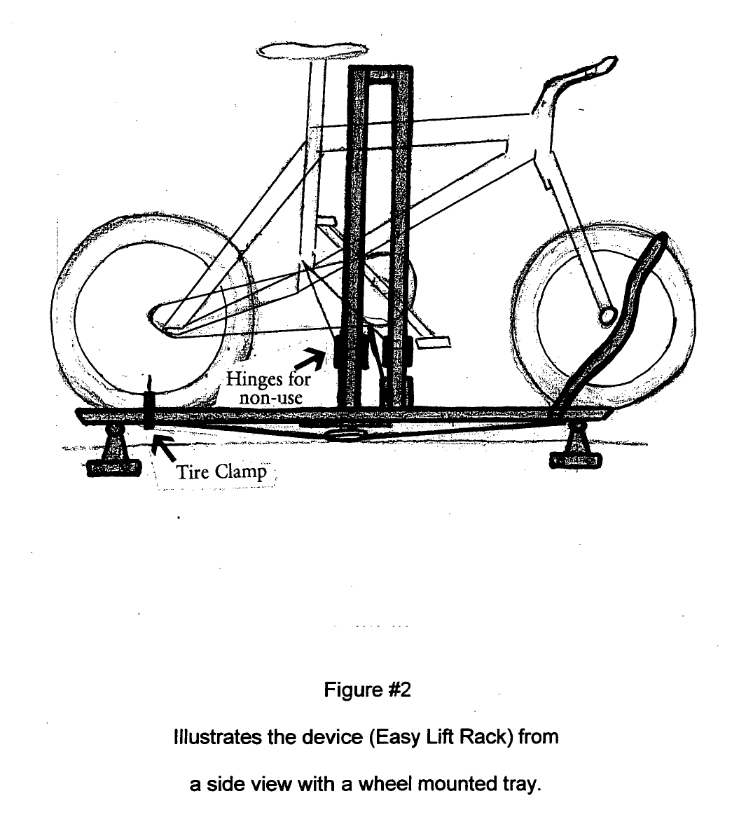

FIG. 2 illustrates the device from a side view with a wheel mounted tray.

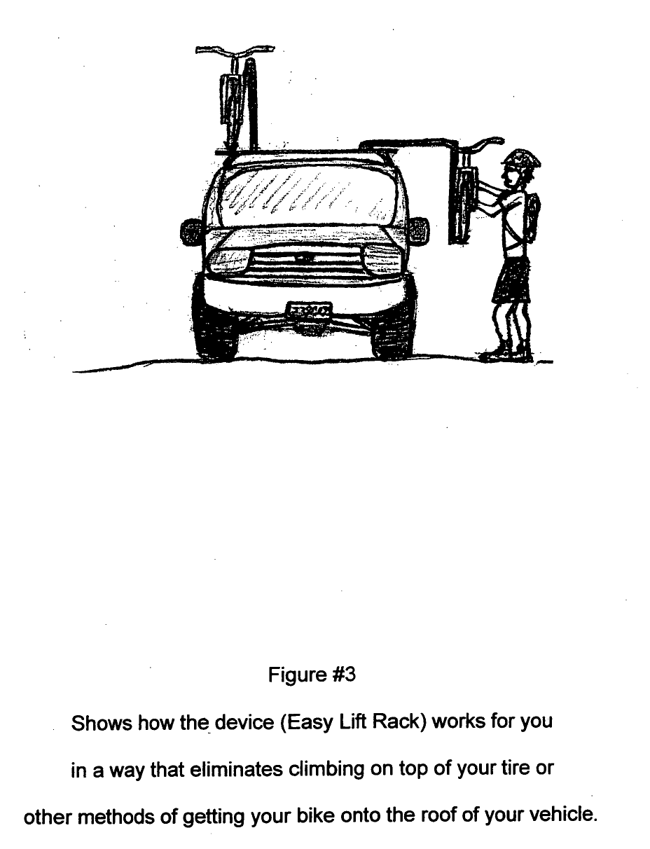

FIG. 3 shows how the device works for you in a way that eliminates climbing on top of your tire or other methods of getting your bike on the roof.

1. I claim that my “easy lift rack” is different from all other inventions of this type because it is the only one that works for you. There is no need to climb, with bike in hand, to the top of your vehicle to mount your bike. Simply squeeze a lever to unlock the tray; and, with little effort, allow the device to lower your bike to you. At the end of your day's travel or riding, simply set your bike on the tray, lock it in position, push it up and drive away.
